(19) United States
(12) Patent Application Publication
(10) Pub. No.: US 2016/0114868 A1
(43) Pub. Date: Apr. 28, 2016

(54) Light conduit underwater illumination system

(71) Applicant: John Burke, Tampa, FL (US)

(72) Inventor: John Burke, Tampa, FL (US)

(21) Appl. No.: 14/523,627

(22) Filed: Oct. 24, 2014

(51) Int. Cl. B63B 45/02; F21V 29/15; F21V 31/00; F21V 33/00

(52) U.S. Cl. CPC B63B 45/02; F21V 33/008; F21V 29/15; F21V 31/005; F21Y 2101/02

(57) ABSTRACT

An apparatus that provides underwater illumination by conducting light from a light source through a light conduit, said light emanating from the distal end of the light conduit into water.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to lights for underwater illumination. Some applications include, but are not limited to, underwater lights for fishing activities, illuminating the water and contents at various depths, illuminating the bottom and structures, and illuminating a underwater area for swimming, snorkeling, SCUBA or free diving activities. Nearly any application where underwater illumination is desired can make use of the invention. Lights for underwater illumination are available in a plethora of colors of visible light. Theses include, but are not limited to, all of the visible spectrum, as well as those in the invisible, including infrared and ultraviolet.

2. Background Art

Lights for underwater illumination may be above the water surface or more typically, contained in water tight enclosures and submerged partially or completely in the water. Above the water lights minimize complexity and the electrical issues associated with being in contact with the water. Being submerged avoids light intensity loss at the air to water interface and enhances heat dissipation of the light source due to water's superior thermal properties. Light sources for underwater illumination include incandescent, fluorescent, high intensity discharge and more recently high intensity LEDs.

Above water light sources may be comprised of electrically generated light, such as those powered from utility electrical sources or battery powered. Alternatively the light source power source may comprise various fuels, one example being a propane gas powered lantern.

Above water lights are typically attached to a structure. Said structures may comprise a fixed or movable form. Examples include, but are not limited to, bridges, docks, boats, poles and combinations thereof.

Above water light systems have the disadvantage of light intensity loss due largely to surface reflection. The reflection loss may be aggravated by water surface conditions, for example ripples or waves. In addition, the surface reflection makes it difficult to see into the water from above the surface. Above water lights also do not benefit from the superior to air thermal properties of water in regard to heat dissipation.

Submerged light power sources are typically comprised of chemical or electrically powered light sources. Chemical light sources are typically used for low intensity and limited time applications. Electrical light sources are typically used for longer time and higher intensity applications. Battery powered electrical light sources are typically more intense than chemical light sources and may have longer useful time. Examples of the battery powered light sources include, but are not limited to, underwater flashlights and underwater camera lights, as well as boat underwater lights. Electrical generator powered light sources are capably of even more intensity and very long use time in respect to the other light sources discussed. Non battery powered electrical light sources typically are connected to an above the water electrical power source, typically derived from utility supplied electrical power. In general, underwater lights have a connection to an electrical power source comprised of a battery, utility source, generator, alternator and combinations thereof. A couple of application examples of the electrical connection powered light sources are swimming pool lights and submerged dock lights. The above description is for illustrative purposes and is not intended to be limiting. Various types and combinations of types of underwater light sources and power sources are possible for use with underwater illumination in a plethora of applications.

Underwater lights may or may not be attached to a structure. The lights could be hand held, attached to water vehicle or not attached to anything. Attachment to a structure may comprise tether to a structure, free floating at the surface or depth, held to the bottom or bottom structure and combinations thereof. Structure is used in the broadest terms and includes, but is not limited to, fixed structures such as piers, docks, buoys and sea walls, as well as pools and spas. It also includes movable structures such as boats, underwater vehicles, barges and other water craft. The list here is not intended to be all inclusive.

Submerged lights present multiple issues: One is maintenance and repair. Since the light is underwater, it is not readily available to replace the light source, repair the unit or for cleaning. Typically the light unit must be removed from the water to perform the required task. Cleaning is a particular issue in marine environments, since surface buildup of marine life forms can reduce light output. A second issue is the necessity of providing electrical power to the light source. In many applications, the electrical power is transmitted via an electrical wire. Electrical wiring in a water environment is potentially problematic in regard to corrosion (particularly marine applications) and safety due to electrification of the water. A third issue is water intrusion into the light unit. Water intrusion into electrical enclosures often results in unit failure. The problem increases with water depth due to increased water pressure. A fourth issue is water intrusion or exit of a structure due to openings associated with submerged mounting of the underwater light to a structure. One example of said openings are the mounting and wiring holes below the water line of a boat. Another example is the mounting and wiring holes in a pool or spa. The preceding examples are illustrative and are not intended to be all inclusive.

Previous underwater illumination systems, both above and below water versions, have the issue of underwater light intensity loss. There are there primary light attenuation causes within the water: The first is the inherent loss of light intensity in water due to the high density of water (as compared with air) and its interaction with light. The loss is wavelength dependent, with colors at the red end of the visible spectrum being attenuated more strongly than those at blue end of the visible spectrum. The second is turbidity. Turbidity tends to scatter or even obscure light and the effect may range from a slight cloudiness to being nearly opaque to light. The third is the spreading of the light wave according to the inverse square law of light, where the intensity of light is inversely proportional to the square of the distance from its source. Obviously theses sources of light intensity loss potentially have a large affect on light intensity at a desired underwater location.

In some applications it may be desired to illuminate a recess or cavity that is otherwise not naturally illuminated. Above the water surface sources are typically of limited usefulness or are not useful for said illumination due to light obstructions inherent in recesses and cavities. Submerged light sources may be utilized to some extent, however their illumination usefulness decreases with distance into the recess or cavity and in nonlinear spaces. Examples of recesses and cavities include, but are not limited to, caves, caverns and the underside of ledges and reefs.

### BRIEF SUMMARY OF THE INVENTION

The invention accomplishes the function of underwater illumination by means of a light conduit. The light conduit conduits the light from a light source or sources to a desired location in the water. At the desired location, light is emitted from the light conduit distal end in the desired pattern. The light conduit distal end is equivalent to a light source device at that location. The light conduit form comprises a plethora of longitudinal and cross sectional shapes. Longitudinal shapes include, but are not limited to, linear, nonlinear and combinations thereof. Cross sectional shapes include, but are not limited to, round, oval, rectangular triangular and combinations thereof. Any longitudinal or cross sectional shape which performs the light conduit function of light confinement and conduction can be utilized. The straight longitudinal form emits the light in the same general direction as the light emerging from the light source, if a redirection device is not present. The nonlinear (one example being a curved) longitudinal form of the light conduit allows the light source light to be redirected in a direction different from the light emission direction of the light source. The light source may also take a variety of forms, including but not limited to, high intensity incandescent and LEDs. The light source may be located above the water, at the surface, below the surface and combinations thereof. By locating the light source above the water, and utilizing the light conduit to transmit the light below the water surface, underwater illumination at a desired location and depth is achieved without the light air to water surface transmission issues, while minimizing water intrusion and other issues associated with submersion of the light source.

Another aspect of the light conduit is that it avoids the light attenuation associated with water density, turbidity and light spreading. The light traveling within the light conduit is conducted to the desired location with minimal loss in intensity or spectral content independent of water path length and turbidity. Attempting to duplicate the same intensity of illumination at a given location from a distant source conducting light through the water, either submerged, above or near the water surface, would require substantially more light intensity or in some cases may not be possible. Yet another issue addressed by the light conduit is light backscatter by suspended particles. Backscatter is illustrated in underwater photography or video as foreground light spots partially obscuring the desired image. Such spots are difficult to suppress or remove from said photographs or video. The light conduit can minimize backscatter by only illuminating the desired area, not particles or objects outside the desired illumination area.

The light conduit is also useful for illumination of a recess or cavity. The light conduit facilitates illumination at a desired location into the recess or cavity without the intensity loss of light traveling through water. Further, the light conduit may comprise a shape which further allows illumination in a nonlinear direction or directions. One example is a curved shape that facilitates illuminating around a corner. The example is for illustration and is not intended to be limiting in any way.

The light conduit also allows the light to be localized in three dimensions under water. The light emitted from the light conduit distal end can be shaped into the desired emission pattern. Further the light conduit distal end can be located such that a desired area of water is illuminated. In some configurations, the light conduit may be divided into one or more linear, nonlinear and combinations thereof longitudinal sections. The sections can be coupled together to form the desired length and shape. By combing a desired emission pattern and a length and shape of the light conduit to reach the desired location, a desired area can be illuminated without illuminating adjacent areas, which also maximizes illumination for a given power source. In some configurations, the light conduit may be divided into one or more longitudinal sections. The sections can be coupled together to form the desired length and shape. For example, the light emission pattern could be set to only illuminate a 180 degree horizontal arc with minimal illumination above, below or in the dark 180 degree horizontal areas. Another emission pattern could emulate a flashlight. The examples are intended to illustrate the concept and is not intended to be limiting in any way.

The light conduit underwater illumination system thus eliminates the issues associated with above the water and submerged light sources illumination systems. These include, but are not limited to, surface reflection, maintenance, water intrusion, water light attenuation and safety issues associated with the previous underwater illumination systems. The light conduit underwater illumination system enables features not present in previous underwater illumination systems, said features comprising distant-from-the-light-source localized underwater illumination, nonlinear path illumination, minimized light conduction loses, configurable light conduit length and shape by utilizing one or more linear, nonlinear and combinations thereof longitudinal sections, a detachable light conduit for easy maintenance and storage, and combinations thereof.

In the broadest form, the invention comprises a base, a connection operable to connect to an electrical power source, an optional electrical power conditioning device, a single color or multiple color light source, said light source comprising one or multiple devices, a fixed or detachable light conduit, said light conduit comprising one or more bars. It further comprising direct emission or a mechanism to redirect and emit the transmitted light out of the light conduit.

The invention is applicable to nearly any underwater lighting application. These include but are not limited to, boats, barges, buoys, navigation structures, piers, docks, seawalls, swimming pools, spas, aquariums and tanks of various types.

The base is operable for mechanical mounting and light coupling between the light source and the light conduit. The base may optionally incorporate the light driver. In various embodiments, the base may have the light source and/or the light driver device incorporated into it or they may be externally connected to it. The base is further operable to couple the light conduit to it. Said coupling may be fixed, detachable and combinations thereof. The base may further optionally comprise attachment to a structure.

The light source may be comprised from a multitude of light emitting devices, one embodiment being a high intensity LED or LEDs. Light as used here, may be comprised of any wavelength or wavelengths of electromagnetic radiation capable of being conducted in the light conduit of the invention.

The electrical power may be from any suitable source which can be used to energize the light source. In one embodiment, the source is the boat's electrical power system or battery. In another, the power is derived from an AC voltage power source, such as an utility service. Many other electrical sources could be used, including but not limited to solar, wind or water movement generated sources.

The light driver device circuit can consists of any device capable of converting the incoming electrical power to a form required by the light source. Examples of such devices include, but are not limited to, a simple connection, a power resistor or switching power topology circuits.

The light conduit may also take a multitude of embodiments. The light conduit comprises one or more adjacent bars. Each bar is essentially a large diameter optical fiber or light pipe, which efficiently conducts and largely contains light within itself. A bar, as defined here, has a solid geometric shape. Examples of geometric shapes include, but are not limited to, cylindrical, half-round cylindrical, elliptical, triangular and rectangular bars and combinations thereof. The cross sectional area of the light conduit, length and shape of the light conduit is determined by the particular application and is not intended to be limiting in any way. In general, any light conduit embodiment that efficiently conducts and largely contains light within itself to the distal end is acceptable for the application.

The longitudinal shape of the light conduit may comprise a linear structure, a nonlinear structure and combinations thereof. The light conduit may be comprised of one or more linear, nonlinear and combinations thereof coupled longitudinal sections. Said coupling may comprise a fixed or detachable connection.

The light conduit may or may not have an external opaque covering. The light conduit external or outer covering, may also be utilized as a thermal path to conduct heat from the light source, light driver, power connection and combinations thereof into the water. For thermal purposes, the covering can take any form and be comprised of any material that is capable of conducting heat to the water. Some material examples include, but are not limited to anodized aluminum, stainless steel, brass and combinations thereof.

The light traveling in the light conduit may be emitted in various ways. It may be emitted from the distal end directly without redirection or may be redirected in any desired pattern or angle.

In the case or light redirection, the light redirection mechanism for the light traveling within the light conduit may take multiple forms. A fundamental characteristic of the mechanism is reflection and redirection of the conduit light. The horizontal light emission may be comprised of any degree pattern up to and including 360 degrees. It may also comprise multiple segmented arcs. Multiple segmented arcs means, for the purposes of this invention, geometric arcs where emission is allowed, not allowed or attenuated. The vertical emission pattern is comprised of an angle up to and including 360 degrees relative to the light conduit vertical or multiple segmented arcs.

In the following section, one embodiment of the invention is explained in detail. The invention is not intended to be limited in its application to the details of construction and to the arrangements of the components described in the following description or illustrated in the drawings. The invention is capable of other embodiments and of being practiced and carried out in various ways.

The phraseology and terminology employed herein are for the purpose of description and should not be regarded as limiting.

It is the intention of the invention to provide a new underwater illumination system which overcomes the disadvantages of previous systems and adds new capabilities which are not anticipated, rendered obvious, suggested, or even implied by any of the prior art.

### BRIEF DESCRIPTION OF THE DRAWINGS

The following drawings illustrate the best modes presently contemplated for carrying out the present invention (Preferred Embodiment).

FIG. 1 Component view of the light conduit underwater illumination System.

FIG. 2 Two Light Conduit Bar With Optional Light Barrier

FIG. 3 Light Redirecting Light Conduit System

FIG. 4 Light Conduit System Above Water Light Source Attachment

FIG. 5 Curved and Linear Light Conduit System

FIG. 6 Light Conduit System Below Water Light Source Attachment

FIG. 7 Light Conduit System Above Water Boat Attachment

FIG. 8 Light Conduit System Submerged Ledge Illumination

### DETAILED DESCRIPTION OF THE INVENTION

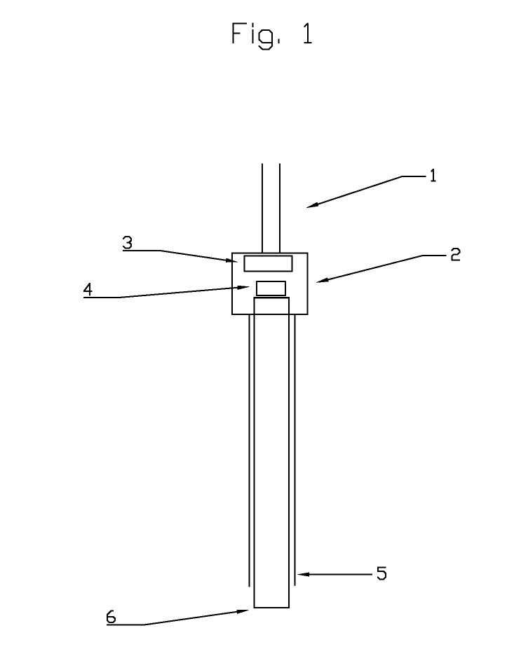

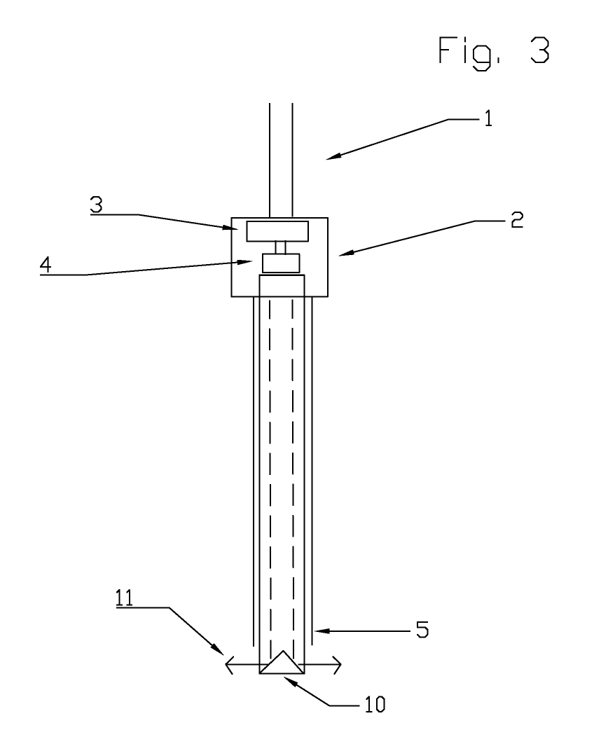

Refer to FIGS. 1, 2, 3, 4, 5, 6, 7 and 8 for the following description.

### Principle of Operation

For the purposes of illustration, the description is of a vertically oriented light conduit, however the orientation can be comprised of nearly any orientation and the description can easily be extrapolated to any orientation.

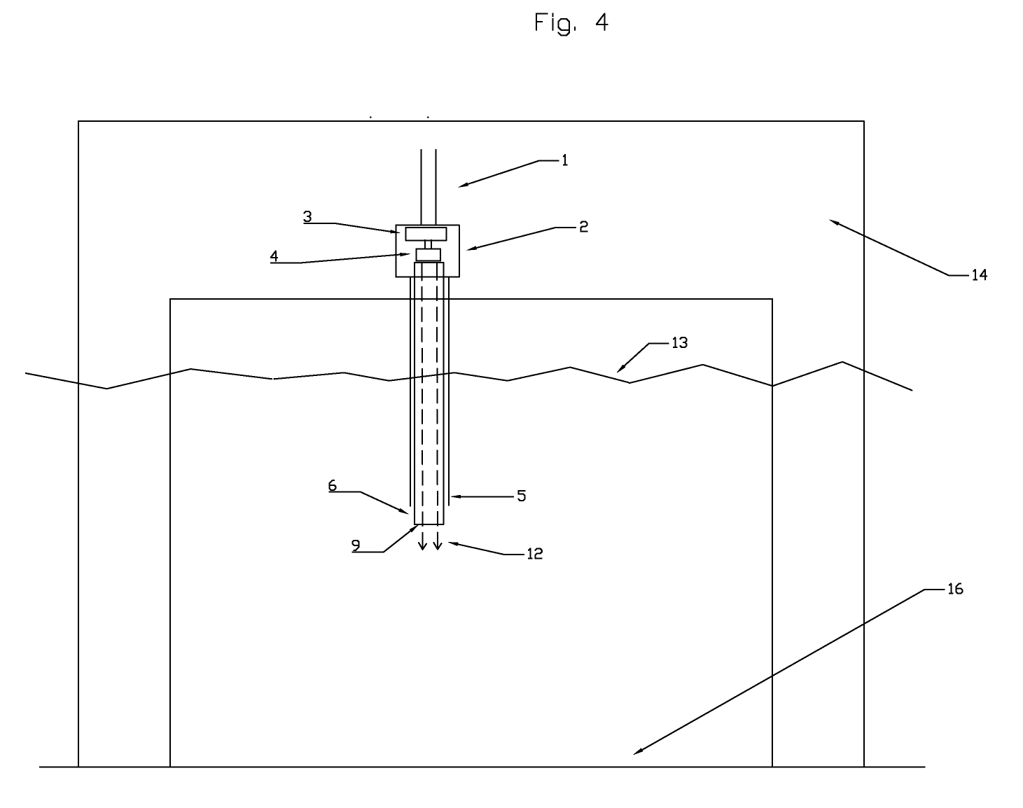

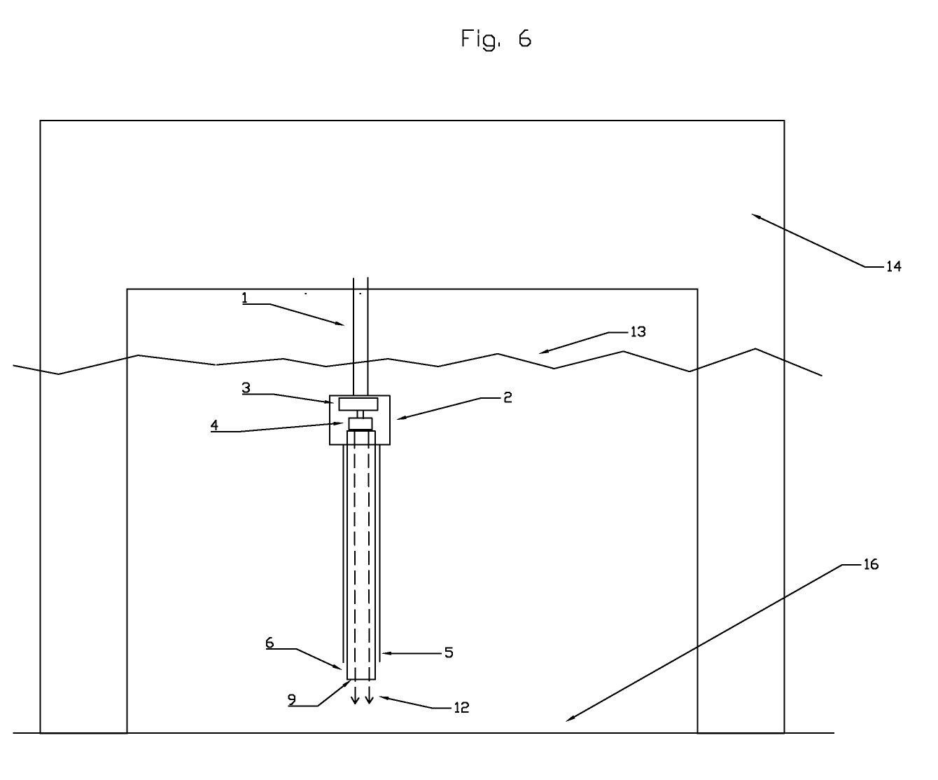

Briefly, the light conduit conducts the light source light to the submerged distal end of light conduit where it emerges into the water. In the case where the light source is located above the water surface 13 (FIG. 4), light is conducted through the light conduit to under the water's surface, therefore light loss, reflection and diffraction at the water surface is avoided. The light conduit material index of refraction is closer to that of water than is the air index of refraction, therefore the light conduit to water interface is more efficient at light coupling than is the air-water interface. Further, whether the light source is above the water surface 13 of FIG. 4 or submerged below the water surface 13 of FIG. 6, the light is confined within the light conduit 6 and does not emerge into the water until it reaches the end of the light conduit, therefore the depth and location of illumination can be controlled. Likewise, the horizontal illumination can be controlled by the light emission pattern of the light conduit. Light as used here, may be comprised of any wavelength or wavelengths of electromagnetic radiation capable of being conducted in the light conduit of the invention. Note that the light conduit of the invention need only be attached to the base and is otherwise not constrained. This allows the light conduit to have a plethora of cross sectional and longitudinal shapes and combinations thereof. It also allows a plethora of mounting, attachment and free-from-attachment forms as only the base needs to be considered regarding said matter.

### The Components:

The preferred embodiment consists of primary components: a base 2, one or multiple light conduits comprising a bar 6 or multiple bars to conduct the light, the light source 4 comprising one or more light emitting devices coupled to the light conduit, one or more light drivers 3 to energize the light source and a connection operable to connect to an electrical power source 1. An optional outer covering 5 may also be incorporated.

The base 2 is operable for mechanical and light coupling of the light source 4 and the light conduit 6. Said coupling may be fixed, detachable and combinations thereof. The detachable light conduit configuration offers the ability to remove it from the water for cleaning, repair or replacement without requiring the base to be disconnected from it attachment. Examples of fixed coupling include, but are not limited to, fasteners, adhesives and welding. Examples of detachable coupling include, but are not limited to, slip fit pin and socket, threaded male and female socket and twist lock connectors. The base may optionally incorporate the light driver 3. In various embodiments, the base may have the light source 4 and/or the light driver device 3 incorporated into it or they may be externally connected to it. The base is optionally operable to attach to a structure.

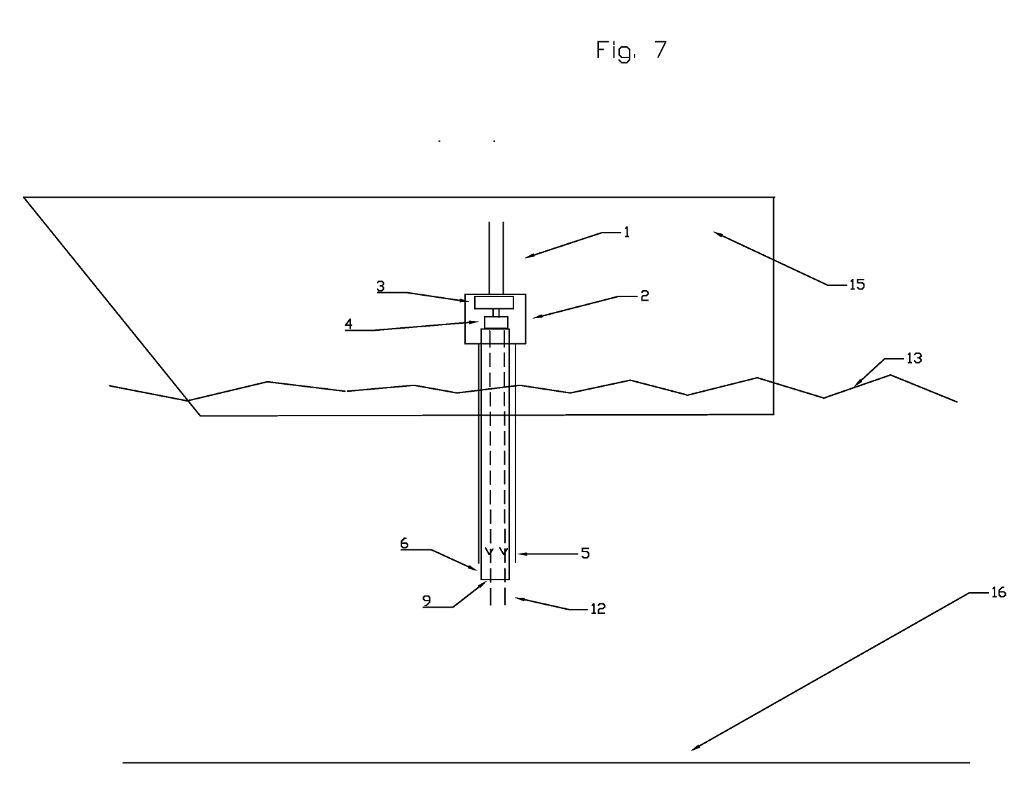

Examples of fixed in place structure 14 attachments are illustrated in FIGS. 4 and 6, which shows a structure fixed to the bottom 16. FIG. 4 illustrates a base 2 positioned above the water surface 13 with the light conduit traversing the air to water interface and emitting the conduit light at depth. FIG. 6 illustrates a base 2 positioned below the water surface 13 with the light conduit emitting the conduit light at depth. Examples of such fixed structures include, but are not limited to, piers, docks and bridges. Another type of structure is movable, one example being the boat 15 illustrated in FIG. 7. Other examples of movable structures include, but are not limited to, floating docks, barges and platforms.

Attachment of the base to a structure may comprise fasteners, adhesives, straps, wires, cables and combinations thereof. Any means of attachment suitable for the application can be used.

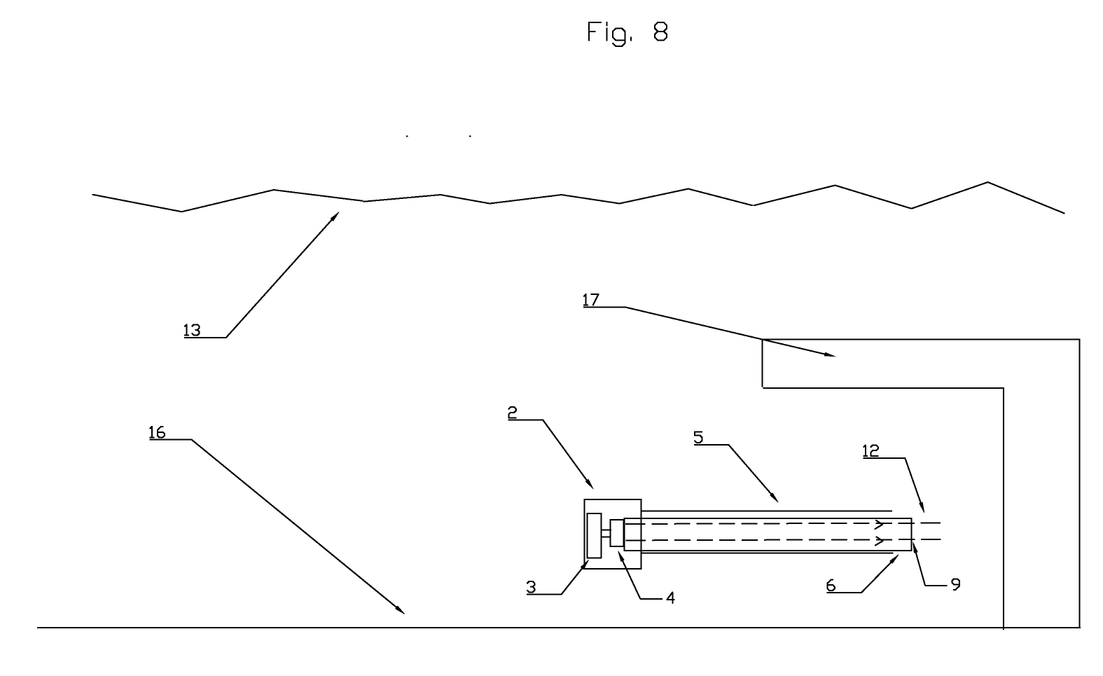

Although the base is optionally operable to attach to a structure for some applications, it is not necessary to the function. In some embodiments the invention is not operable to attach to a structure. Some unattached embodiments are suitable to be hand carried. One example application of an unattached embodiment is illustrated in FIG. 8, the illumination of the underside of a submerged ledge 17. In summary, the base may be operable or not operable to attach to a structure, or be capable of both.

The base 2 may be constructed of any material suitable for the environment. Examples include aluminum, stainless steel, a variety of plastics and composites and combinations thereof. The preferred embodiment material is comprised of anodized aluminum.

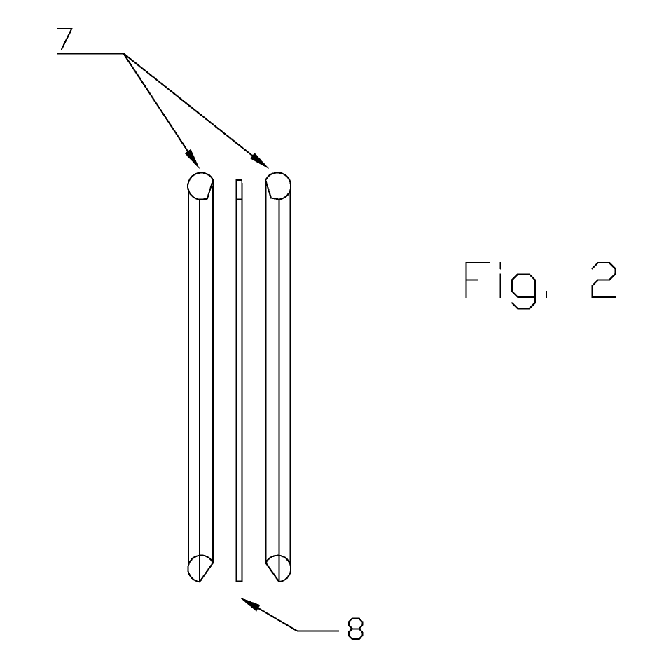

The light conduit may be comprised as a single bar 6 or two 7 or more adjacent bars with an optional light barrier 8 between adjacent bars. FIG. 2 depicts a two bar light conduit, said two bar light conduit can be easily extrapolated to more than two bars. The light conduit is coupled to the base and need not be attached to any other structure. The light conduit coupling to the base may be detachable or fixed. The optional light barrier 8 is opaque to light and prevents light from being emitted along the adjoining surfaces of the light conduit bar or bars. The barrier can also be extrapolated to multiple barriers.

The light conducting material of the preferred embodiment light conduit bars 6,7 is acrylic. Alternative materials include, but are not limited to glass, polycarbonate and combinations thereof. The light conduit material may be comprised of any optically transparent material that efficiently confines and conducts light. The cross section size of the light conduit bars 6,7 is not critical and is primarily determined by the proximal end surface area needed by the light conduit bars 6,7 to efficiently couple their respective light source 4 radiation pattern. Again, extrapolation to more than two light bars is easily made. Other cross section considerations are structural integrity and the size of the illumination area.

The length of the light conduit bar or bars is not critical, and can be varied to meet the length requirements of the application. The primary limitation on the length of the light conduit bar 6 or bars is light intensity loss, however that can be offset by higher light source 4 intensity. For the above the water surface embodiment, the conduit length is largely controlled by the light source height above the water surface and the distance to the desired illumination area. For the submerged embodiment, the conduit length is largely controlled by the distance to the desired illumination area. The dimensions of the light conduit bars 6,7 are not intended to be a limitation in any sense, since the length and cross section of the light conduit bars 6,7 can be of nearly arbitrary dimensions, as needed by the application.

The light conduit bar 6 or bars 7 likewise can be of nearly any shape as desired for the application. The preferred embodiment utilizes a cylindrical bar, however that is in no way intended as limiting. A plethora of shapes including, but not limited to, cylindrical, half-round cylindrical, square, triangular and rectangular bars and combinations thereof could be used.

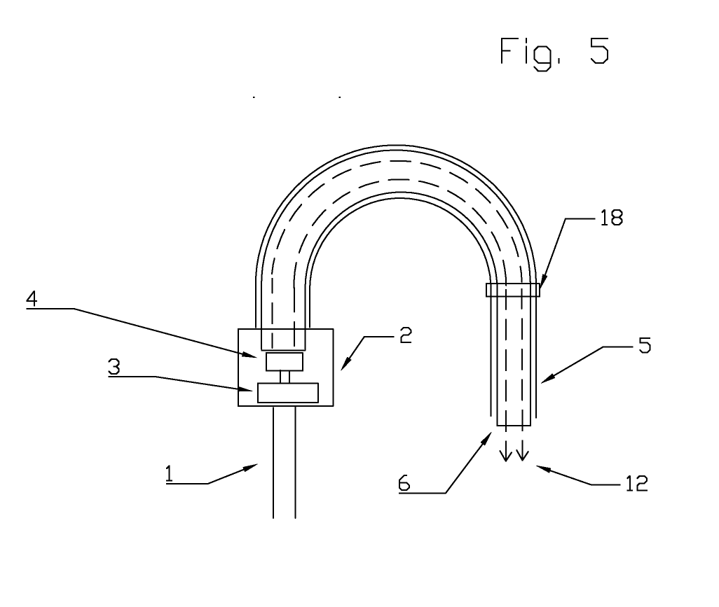

An additional advantage of the light conduit is that it may comprise a linear, nonlinear and combinations thereof longitudinal shape. Further, one or more additional light conduits may be coupled to form the desired length and shape. Said coupling 18 may be fixed or detachable. The detachable coupling of light conduits offers smaller size for easier transport. Said linear, nonlinear and combination shape of the light conduit facilities directing light to a specific location without the need to orient the light source in a particular direction. One example of the preceding is shown in FIG. 5, where a combination curved and linear light conduit bar 6 directs light in the opposite direction of the light source emitted light direction. This example is for illustrative purposes and is not intended as limiting. A plethora of linear, nonlinear and combinations thereof configurations of the light conduit are possible.

The optional light barrier 8 construction may be comprised of foil, film, coating, deposition and combinations thereof of light opaque material. Examples of such materials include, but are not limited to, aluminum, steel, copper, opaque plastics, composites and combinations thereof.

The distal end of the light conduit bar 6 or bars 7 permit the light to exit the distal end with 11 or without 12 redirection. In the case of redirection, there is a light redirection device 10 to redirect the light traveling in the light conduit bar 6 or bars outward from the light conduit in the desired horizontal light emission pattern 11. Alternately, the distal end redirection device 10 may redirect only a portion of the light in a horizontal pattern 11, with the remaining light emerging from the distal end in a vertical pattern 12. In the case of no redirection of the conduit light, light redirection device 10 is not present and therefore the light emerges from the conduit distal end in essentially the same direction of travel as in the conduit. Again, this description is for illustration purposes and is not intended to be limiting. A plethora of redirection, non redirection and combinations thereof are possible. The redirection devices 10 may be integral to the light conduit bar 6 or bars 7, external to it or a combination thereof. In the case of the integral light redirection devices 10, each redirection device is comprised of an optical discontinuity with an optional additional reflective material at the exterior surface of said optical discontinuity. For the external case, the light redirection devices are comprised of optical discontinuities in the form of reflective surfaces external to the distal end of the light conduit. Whether the light redirection occurs integral (internal) to or external to the light conduit, the light redirection function is fundamentally the same.

The light redirection device 10 may comprise any material or combinations of materials that efficiently redirect the light. The integral redirection device 10 is a boundary between materials with differing indexes of refraction and an optional additional reflective surface. More specifically, the light conduit material side of the boundary has a relatively high index of refraction and the other side of the boundary has a relatively low index of refraction. The reflective material used by both the optional additional reflective surface and the external redirection device is comprised of various metal, plastic, composites and combinations thereof that have sufficient light reflection properties. Examples of the reflective materials form is comprised of films, foils, depositions and combinations thereof. Other forms are possible and the examples are not intended to be limiting.

In the case of the redirected conduit light configuration of the preferred embodiment, the light conduit bar 6 or bars have a shaped optical discontinuity surface integral to the distal end to form the light redirection devices 10. One side of the surface is comprised of acrylic and the other side is comprised of aluminum, water, air and combinations thereof, thereby comprising the optical discontinuity. There is an additional reflective surface present at the exterior surface of the cone comprised of aluminum foil to enhance light reflection.

In the case of the redirected conduit light configuration of the preferred embodiment, the light redirection devices 10 of the light conduits form an angle of ninety degrees. Said ninety degree angle creates a forty five degree angle of incidence between the redirection device surface and the impinging light 12. The conduit light 11 emerging in a essentially perpendicular in direction in respect to the light conduit. The ninety degree surface angle is not intended to limit the possible angles in any way and any angle that redirects the light in the desired pattern is acceptable.

In the case of the non redirected conduit light of the preferred embodiment, the distal end of the light conduit 9 may comprise a shape suitable to the desired emission pattern. Some examples comprise flat, concave, convex and combinations thereof. The shape example are not intended to be limiting.

The single bar configuration FIG. 1 light conduit 6, may have an optional opaque outer covering 5. Again, the optional outer covering can easily be extrapolated to a multiple light conduit bar configurations. The outer covering 5 may be comprised of any light opaque material suitable for the application, including, but not limited to, aluminum, copper, steel, opaque plastics, opaque coatings and combinations thereof. In the preferred embodiment, an aluminum outer covering 5 is used.

In the case of single bar light conduit configuration of FIG. 1, typically there is one light device of one color comprising the light source 4. However, multiple colors and/or devices may also comprise the light source 4. As in other aspects of the invention, the single bar case of the light conduit configuration can easily be extrapolated to multiple bars in the light conduit.

The light emitted from the light source 4 is directed into the proximal end of the light conduit bar 6 or bars. FIG. 1 depicts the configuration where the light source 4 is internal to the base 2 and located at the proximal end of the light conduit bar 6 or bars so as to minimize physical separation between the light source 4 and the light conduit bar 6 proximal end.

### Description of Operation

### Electrical Section

The base 2, has a connection operable to connect to an electrical power source 1. Said connection may comprise wires, terminals, connectors and combinations thereof 1. Said electrical power source is comprised of a boat electrical power system, a battery, a DC or AC power source, an electrical utility system and combinations thereof. The base 2 also comprises the light source 4 and the light source driver device or devices 3. Said light source 4 and the light source driver device or devices 3 need not be incorporated into the base.

In the preferred embodiment, the light source 4 is comprised of one or more state-of-the-art high intensity LEDs (Light Emitting Diode), available from multiple semiconductor manufacturers. The invention anticipates continuing advancements in LED technology which will provide more light output for less power consumption, hence improving overall efficiency and enabling longer light conduit bar 6 or bars lengths, lower power consumption and combinations thereof. Light source 4 embodiments comprise LED or LEDs, incandescent bulb or bulbs, florescent bulb or bulbs, HID lamp, LASER or LASERS, and combinations thereof. The list of light sources is not intended to be limiting.

The light source 4 are driven by the light source driver device 3 which conditions the electrical power presented via the electrical connection 1 to the electrical drive requirements of the light source 4. In some embodiments, the light source driver device 3 may do minimal or no conditioning of the electrical power.

In the preferred embodiment, the LED light source driver device 3 can be comprised of a simple voltage dropping power resistor, a linear power supply topology, a switching power supply design and combinations thereof. For most application the switching power supply design is preferred due to its low power dissipation and accurate LED current control. Multiple semiconductor manufactures provide switching power supply based LED driver circuits. The voltage dropping resistor or linear supply is suitable to applications were the input voltage and LED current will not result in excessive power dissipation.

In the preferred embodiment, the LED light source 4 and the LED light source driver device 3 are thermally conductive epoxy encapsulated within the base to prevent water damage and conduct heat away from the electrical components. There is no inherent need to thermal epoxy encapsulate the light source 4 and/or the light source driver device 3. Other examples of possible embodiments are comprised of sealed enclosures with air, silicone or other gel fillings, dielectric grease and combinations thereof. These examples are for illustrative purposes and are not intended to be limiting. Any encapsulation or sealing configurations that accomplish the goal of preventing water intrusion are suitable.

### Optical Section

The light emerging from the light source 4 is optically coupled into the light conduits bar 6 or bars.

The light 12 coupled into the proximal end and traveling within the middle portion of the light conduit bar 6 or bars experiences nearly total internal reflection, thereby efficiently confining conducting the light to the distal end. The phenomena of total internal reflection is well know to those skilled in the field of fiber optics and relies on the light conduit bar 6 (core) having a higher index of refraction than the surrounding media, which is comprised of air, water, an outer covering 5 (cladding) and combinations thereof.

Materials that have good light transmission properties and can be made to provide nearly total internal reflection are candidates for the light conduit bar 6 Such materials include, but are not limited to, acrylic, glass and polycarbonate and combinations thereof. The light conduit bar 6 or bars in the preferred embodiment is (are) comprised of acrylic, which has excellent light transmission properties and is compatible with water.

For the preferred embodiment, the aluminum outer covering 5 of the light conduit bar 6 or bars further increases the internal reflection and blocks light from emerging along the periphery of the light conduit bar 6. The aluminum outer covering 5 has an index of refraction lower than that of the light conduit bar 6 or bars minimizing light loss. The outer covering 5 also provides protection to the light conduit bar 6 or bars from mechanical stress. In some configurations, the outer covering 5 further provides a thermal path to the water. The use of aluminum as the outer covering 5 is not intended to be limiting as a variety of material can be utilized as discussed previously.

In the non redirected light form of the preferred embodiment, the distal end of light conduit bar 6 has a flat surface 9 which is essentially perpendicular to the light conduit bar. The light 12 traveling within the light conduit bar 6 encounters the light conduit bar to water interface at the light conduit distal end flat surface 9 and is largely conducted into the water in essentially the same direction as it traveled in the light conduit as it emerges from the light conduit distal end.

In the redirected light form of the preferred embodiment, the distal end of the light conduit bar 6 has cone shaped light redirection device 10 in the light conduit. The light 12 traveling within the light conduit bar 6 is reflected by the cone light redirection device 10 and is emitted from the light conduit bar 6. Since the light 12 traveling in the light conduit bar 6 impinges essentially the entire reflective surface of the cone light redirection device 10, the redirected light 11 is emitted in a three hundred sixty degree horizontal pattern around the distal end of the light conduit bar 6 or bars. The light redirection devices 10 can be integral to the light conduit bar 6 (as in the case of the preferred embodiment) or can be external at the distal end of the light conduit bar 6.

In the case of external light redirection, the light 12 traveling in the light conduit 6 emerges from the light conduit material at the distal end and continues on to encounter the external light redirection devices. It is there that the light 12 is redirected in the same manner as in the integral case.

In the preferred embodiment, the cone shaped light redirection devices 10 were chosen for their uniform light emission characteristic, however it is anticipated that a plethora of other shapes for the redirection devices 10 could be utilized, depending on the desired light emission pattern.

In the preferred embodiment, the light emitted from the optical discontinuity of the light conduit bar 6 is somewhat diffused by its nature. However, it may be desirable to have a more diffused light. To that end, the light conduit may have a light diffuser comprised of a roughened surface of the light conduit material, an external diffused covering and combinations thereof.

1) A light conduit underwater illumination system, comprising:
a light source, said light source comprising one or more light emitting devices;
a light conduit or multiple coupled light conduits, each said light conduit comprising one or multiple light confining and conducting bars, said light conduit or multiple coupled light conduits comprising a proximal end operable to receive the light source light, a middle portion that conducts and confines said light within itself, and a distal end operable for said light to emerge into the underwater environment, said light conduit or multiple coupled light conduits operable to be at least partially submerged;
a base, said base comprising housing or attachment of the light source, coupling of the proximal end of light conduit or multiple coupled light conduits and able to be located above the water surface, at the water surface, below the water surface and combinations thereof.

2) A light conduit underwater illumination system in claim 1, wherein the light source comprises a Light Emitting Diode (LED) or multiple LEDs.

3) A light conduit underwater illumination system in claim 1, wherein the light conduit comprises a bar or multiple bars, said bar shape comprising, but not limited to, half-round, round, triangular, ellipse, rectangular and combinations thereof.

4) A light conduit underwater illumination system in claim 1, wherein the light conduit bar material comprises acrylic, polycarbonate, glass and combinations thereof.

5) A light conduit underwater illumination system in claim 1, wherein the light conduit or multiple coupled light conduits longitudinal shape is comprised of linear, nonlinear and combinations thereof.

6) A light conduit underwater illumination system in claim 1, wherein the light conduit or multiple coupled light conduits comprise an outer covering, said outer covering material comprising aluminum, copper, steel, stainless steel, opaque plastics, opaque coatings and combinations thereof.

7) The light conduit or multiple coupled light conduits outer covering in claim 6, wherein the outer covering comprises a thermal path.

8) A light conduit underwater illumination system in claim 1, wherein the coupling of the proximal end of the light conduit or multiple coupled light conduits to the base is a detachable type.

9) A light conduit underwater illumination system in claim 1, wherein the coupling of the proximal end of the light conduit or multiple coupled light conduits to the base is a fixed type.

10) A light conduit underwater illumination system in claim 1, wherein the coupling of each of the multiple coupled light conduits is a detachable type.

11) A light conduit underwater illumination system in claim 1, wherein the coupling of each of the multiple coupled light conduits is a fixed type.

12) A light conduit underwater illumination system in claim 1, wherein the distal end of the light conduit or multiple coupled light conduits comprises a light redirection device, said redirection device operable to emit the conduit light in a desired pattern.

13) A light conduit underwater illumination system in claim 1, wherein the distal end of the light conduit or multiple coupled light conduits comprises direct light emission.

14) A light conduit underwater illumination system in claim 1, wherein the base is operable to be attached to a structure, said structure comprising piers, docks, buoys, platforms, poles, sea walls, boats, underwater vehicles, barges, other water craft and combinations thereof.

15) A light conduit underwater illumination system in claim 1, wherein the base is operable to be free from attachment to a structure.

16) A light conduit underwater illumination system in claim 1, wherein the base is operable to be located largely vertically above the water surface, wherein the light conduit is operable to traverse the water surface and penetrate into the water to a desired location.

17) A light conduit underwater illumination system in claim 1, wherein the base and the light conduit are operable to be partially or completely submerged.
